(19) United States
(12) Patent Application Publication
(10) Pub. No.: US 2012/0279109 A1
(43) Pub. Date: Nov. 8, 2012

(54) Artificial Weed System for Ice Fishing

(76) Inventor: David J. Nichol, Gainesville, GA (US)

(21) Appl. No.: 13/196,065

(22) Filed: Aug. 2, 2011

Related U.S. Application Data
(63) Continuation-in-part of application No. 13/101,603, filed on May 5, 2011.

(51) Int. Cl. A01K 97/01; A01K 99/00

(52) U.S. Cl. 43/4.5; 43/4

(57) ABSTRACT

An artificial weed system for attracting fish while ice fishing, includes a flexible line having a distal end. At least one elongated rod is affixed to the line at a predetermined position. At least one artificial weed bundle is affixed to the rod and includes a first end that is affixed to the rod. The at least one artificial weed bundles include a plurality of strands extending from the first end. Each strand has a specific gravity that is no greater than 1.0 and each strand includes a synthetic filament. A weight is affixed to the distal end of the line.

### CROSS-REFERENCE TO RELATED APPLICATION(S)

This application is a continuation-in-part of, and claims the benefit of, U.S. patent application Ser. No. 13/101,603, filed May 5, 2011, the entirety of which is hereby incorporated herein by reference.

### BACKGROUND OF THE INVENTION

1. Field of the Invention

The present invention relates to fishing tackle and, more specifically, to an artificial weed system for attracting fish.

2. Description of the Related Art

Fishing is a popular activity throughout the world. Avid anglers frequently seek to fish in areas having weed growth because fish are frequently found in such areas. Typically, small bait fish go into the weeds to hide from larger game fish. The game fish are attracted to such areas because they are more likely to find the bait fish there.

Many artificial lakes and lakes in rocky environments lack large scale weed growth. To compensate for this, anglers will sometimes cut branches off of trees, add weights to them and place them into the water to create an artificial environment to attract fish. This practice results in damage to the trees at the shoreline and the results are temporary since the tree branches tend to decay over time. It is also time consuming for the angler.

In the context of ocean fishing, many littoral areas with sandy bottoms lack substantial weed growth. Also, in the context of deep sea fishing, there tend not to be any weeds at the depths where desired game fish inhabit.

Therefore, there is a need for portable system for introducing artificial weeds to a body of water to attract fish.

### SUMMARY OF THE INVENTION

The disadvantages of the prior art are overcome by the present invention which, in one aspect, is an artificial weed system for attracting fish that includes a circular hoop and a plurality of spaced apart artificial weed bundles. The circular hoop has a first end and a opposite second end. Each of the plurality of spaced apart artificial weed bundles is affixed to the hoop. Each weed bundle includes a first end that is affixed to the hoop, each of the plurality of artificial weed bundles includes a plurality of strands extending from the first end. Each strand has a specific gravity that is no greater than 1.0 and each strand includes a synthetic filament. A first attachment device is affixed to the first end of the hoop and a second attachment device is affixed to the second end of the hoop.

In another aspect, the invention is a synthetic weed system that includes a frame, at least one artificial weed bundle, a float and an anchor. The frame has a first end and a opposite second end. The at least one artificial weed bundle has a first end affixed to the frame and a plurality of strands extending from the first end. Each of the plurality of strands has a specific gravity that is no greater than 1.0 and includes a synthetic artificial turf filament. The float is coupled to the first end of the frame. The anchor is coupled to the second end of the frame.

In another aspect, the invention is an artificial fish cover system in which at least one first frame is disposed in a body of water at a depth corresponding to a habitat zone. Each of a plurality of bundles of synthetic grass blade strands is spaced apart and attached to the first frame at a first end. A float, a portion of which is disposed in the body of water, is coupled to the first frame so as to suspend the frame in an upright position. A weight is coupled to the first frame and is disposed in the body of water.

In another aspect, the invention is an artificial weed system for attracting fish while ice fishing, that includes a flexible line having a distal end. At least one elongated rod is affixed to the line at a predetermined position. At least one artificial weed bundle is affixed to the rod and includes a first end that is affixed to the rod. The at least one artificial weed bundles include a plurality of strands extending from the first end. Each strand has a specific gravity that is no greater than 1.0 and each strand includes a synthetic filament. A weight is affixed to the distal end of the line.

In yet another aspect, the invention is a method of attracting fish to a location in a body of water that is covered with a layer of ice, in which a hole, having a diameter, is drilled in the layer of ice so as to facilitate access to unfrozen water in the body of water. A weight that is affixed to a line is placed through the hole. A vertically disposed elongated rod is placed through the hole. The elongated rod is affixed to the line and at least one artificial weed bundle that includes a plurality of elongated strands extending therefrom, each strand comprising a synthetic filament is affixed to the rod.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a plan view of one representative embodiment of an artificial weed system.

FIG. 2 is an elevational view of one embodiment of an artificial weed system in use.

FIG. 3 is an elevational view of a multi-unit artificial weed system.

FIG. 4 is an elevational view of a spiral embodiment multi-unit artificial weed system.

FIG. 5 is an elevational view of a linear embodiment multi-unit artificial weed system.

FIG. 6A is a detail of an artificial weed system with an integrated chum holder.

FIG. 6B is a detail of an artificial weed system with a separate chum holder.

FIG. 6C is a detail of an artificial weed system showing an alternate method of affixing artificial weed bundles to the frame.

FIGS. 7A and 7B are elevational views of an embodiment that may be used for ice fishing.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

U.S. Pat. No. 3,332,828, issued to Faria et al., discloses a monofilament ribbon pile product used in artificial turf applications and is incorporated herein by reference for the purpose of disclosing grass-like filaments.

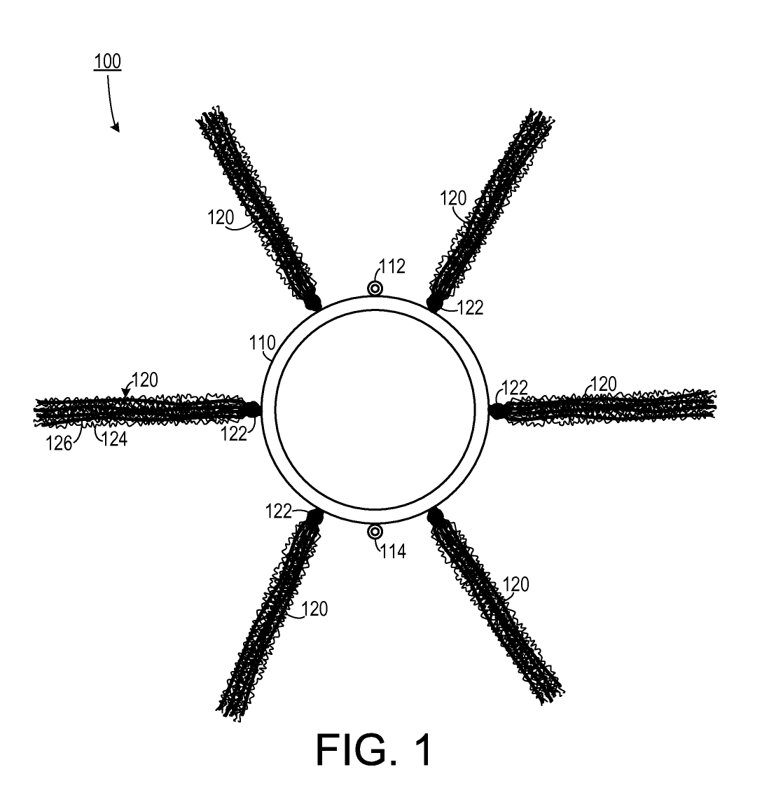

As shown in FIG. 1, one embodiment of an artificial weed unit 100 includes a frame 110, which could be a circular hoop or a structure having one of many other shapes, to which a plurality of spaced apart artificial weed bundles 120 is affixed. In one embodiment, the frame 110 includes a circular hoop made from a polyvinyl chloride (PVC) tube (in other embodiments, it could include any material capable of resisting corrosion while being immersed in water, such as a fiberglass rod). Each weed bundle 120 includes a first end 122 that is affixed to the frame 110.

Each weed bundle 120 includes plurality of synthetic filament strands (which in one embodiment can include fine crinkled strands 124 and grass blade shaped strands 126, other shapes of strands could also be employed to simulate other weed configurations) that extend from the first end 122. In one embodiment, the strands have a color (such as green or brown) that corresponds to the color of natural weeds found in the body of water in which the device is intended to be used. In one embodiment, the strands 124 and 126 have a specific gravity that is no greater than 1.0 so that when the bundle 120 is placed in a body of water, the strands 124 and 126 either tend to float or are neutrally buoyant so as to appear like natural weeds or algae. In one embodiment, the strands could have a specific gravity of greater than 1.0 where it is desirable for the strands to hang down from the frame, such as in certain deep sea fishing applications. In one embodiment, the plurality of strands includes an extruded monofilament material including a polymer such as: a nylon; a polyester, a polypropylene and copolymers thereof. The strands can be made from the type of fiber generally employed in artificial turf surfaces.

A first attachment device 112 may be affixed to a first end of the frame 110 and a second attachment device 114 may be affixed to a second end of the hoop 110. These attachment devices 112 and 114 could include ring-shaped structures that are integrated with the frame 110, loose rings that encircle a portion of the frame 110, a plastic connector (such as a cable clamp or a nylon cable tie or a piece) that encircles a portion of the frame, or even a short piece of flexible line or non-corrosive wire that is tied or wrapped about a portion of the frame. The attachment devices 112 and 114 can be used for attaching floats, weights, retrieval lines and other frames to the frame 110.

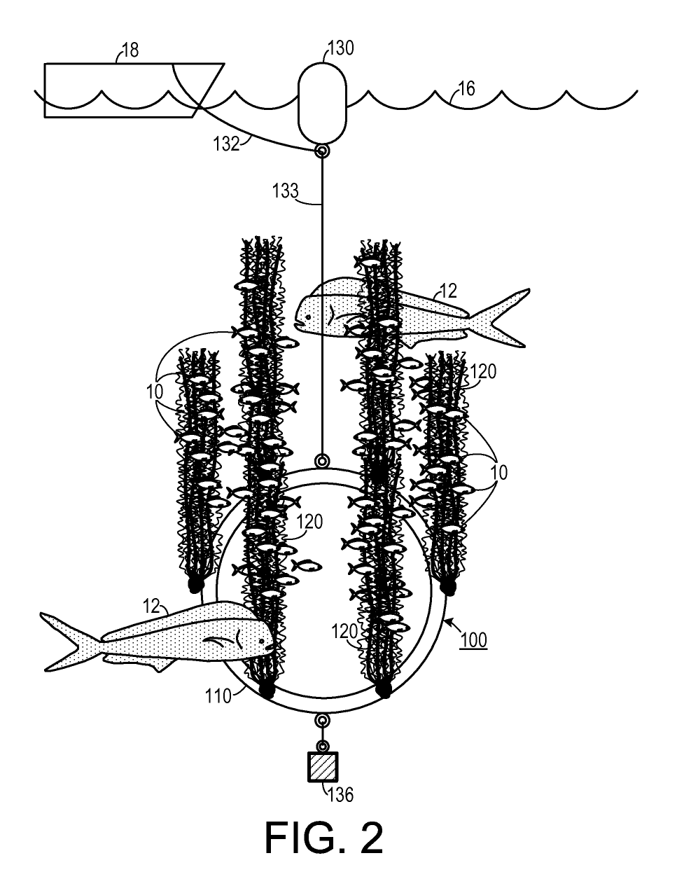

As shown in FIG. 2, in an embodiment that would typically be used in a deep sea fishing application, a float 130 is attached to a top portion of the frame 110 with a line 133 of sufficient length so that the frame 110 is suspended at a depth where fish are thought to inhabit while the float 130 floats at the surface 16 of the body of water. A retrieval line 132 can be attached either to the float 130 or the frame 110 to keep the device within a desired distance of a fishing boat 18. In this embodiment, a weight 136 is either suspended from the bottom of the frame 110 or integrated into the frame 110 to maintain the frame 110 at the desired depth. This embodiment provides what appears to be a growth of weeds that attracts small bait fish 10, which attract sport fish 12.

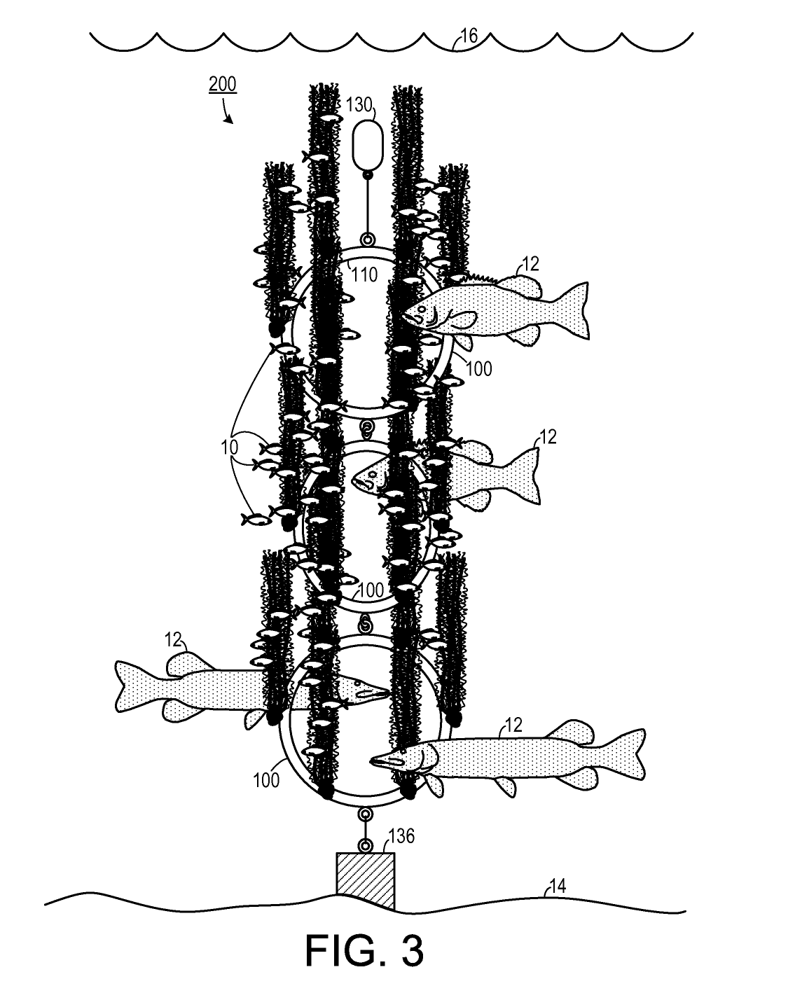

As shown in FIG. 3, several artificial weed units 100 can be interconnected to create a larger artificial weed structure 200. Many configurations of artificial weed units 100 are possible, including vertical chains of weed units 100, horizontal chains, diagonal chains and combinations thereof. The embodiment shown would be typical for use in a relatively shallow lake, where the weight 136 anchors the structure 200 to the bottom 14 of the lake and the float 130 (which could be integrated in one or more of the frames 110) holds the structure 200 in an upright position. In this embodiment, the float 130 is kept under the surface of the water 16 to preserve the secrecy of where the artificial weed structure 200 has been placed. In certain embodiments, keeping the frame 110 and the weed bundles 120 above the bottom surface 14 is important because if the weed bundles 120 are kept at the bottom surface 14, they can begin to silt up, which will cause them to lay down and become ineffective.

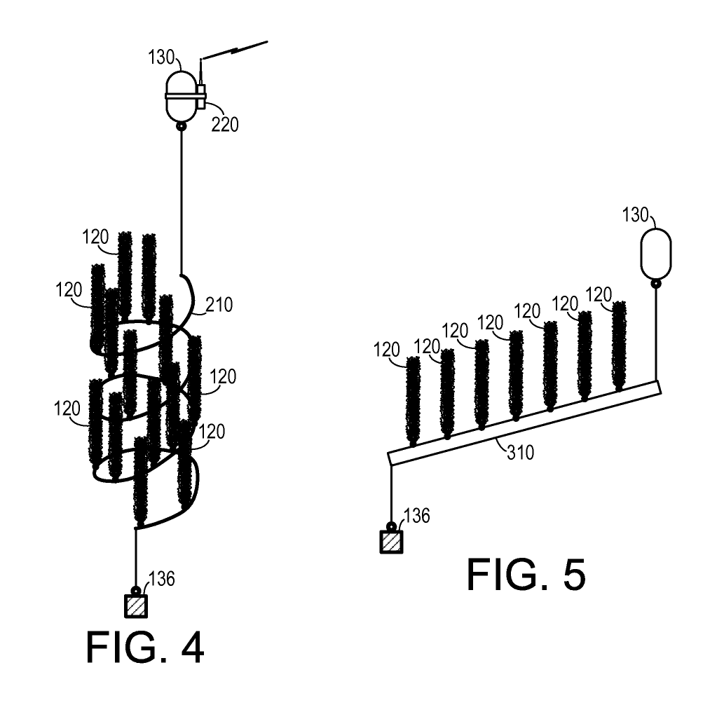

It will be understood that the frame can have one of many shapes. For example, a collapsible spiral frame 210 is shown in FIG. 4. In this embodiment, the frame could include flexible tubing that is pre-stressed so as to collapse into a spiral member when external forces (such as from a float 130 and an anchor weight 136) are not applied to the ends of the frame 210. This embodiment also shows a locating signal transponder 220 that is integrated with the float 130 (which could alternately be affixed to the frame 210). The transponder 220 could be used to locate the device. Another configuration for the frame 310 is shown in FIG. 5, in which the frame 310 is simply a liner PVC tube to which the weed bundles 120 are attached. This embodiment is easy to construct and takes little storage space. It will be appreciated that many other frame shapes (e.g., rectangular, triangular, spherical, conical, etc.) and materials may be employed without departing from the scope of the invention.

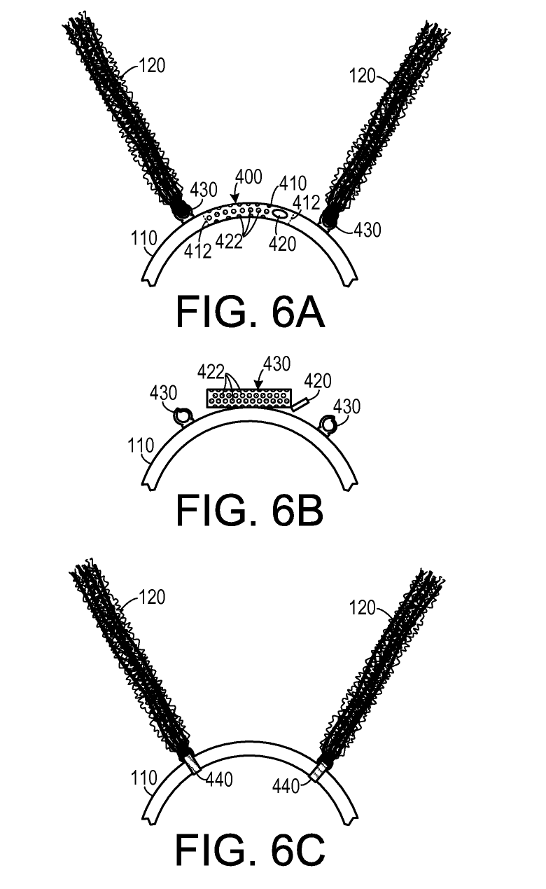

As shown in FIG. 6A, a chum holder 400 can be integrated into the frame 110. The chum holder 400 can include a tubular portion 410 that is separated from the frame by a pair of internal walls 412 so as to create a cavity configured to hold chum therein. A door 420 allows for placement of chum into the cavity when the door is open. A plurality of holes 422 that open into the cavity allows for liquids and small particles to drift out of the cavity into the water, thereby further attracting fish. FIG. 6A also shows one embodiment of attaching the weed bundles 120 to the frame 110, in which releasable electrical cable clamps 430 are affixed to the frame 110. These clamps 430 allow the user to disconnect the weed bundles 120 from the frame 110 to facilitate storage and cleaning These clamps 430 are shown in FIG. 6B without weed bundles attached thereto. Also shown in FIG. 6B is a configuration wherein a separate chum tube 430 is coupled to the frame 110. This configuration can allow the chum tube 430 to be cleaned and stored separately from the frame 110.

An alternate method of attaching the weed bundles 120 to the frame 110 is shown in FIG. 6C, in which a piece of heat shrink tubing 440 is placed about a portion of the frame 110 and the strands of the weed bundles 120 are fed through the heat shrink tubing 440. The heat shrink tubing 440 is then heated so as to cause it to shrink, thereby affixing the strands to the frame 110.

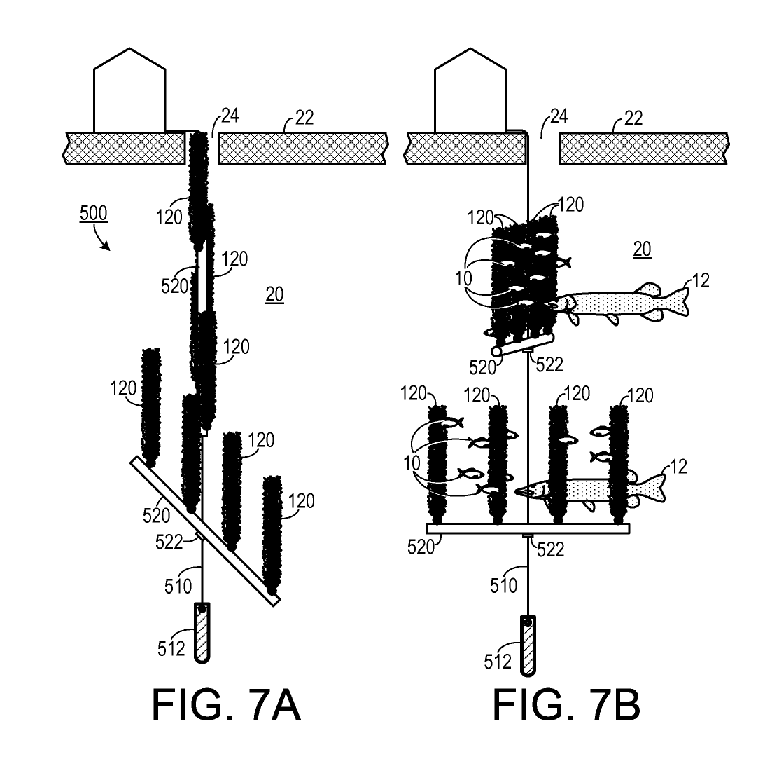

As shown in FIGS. 7A and 7B, one embodiment of an artificial weed system 500 is particularly useful for attracting fish while ice fishing. In this embodiment, the weed bundles 120 are affixed to elongated rods 520 (such as PVC tubes) that are affixed to a line 510 (such as a synthetic aramid, nylon, polyester, polypropylene, or polyethylene line). An elongated weight 512 is affixed to the distal end of the line 510. An adjustable clip 522 can be used to select a vertical location along the line 510 to which the rod 520 is affixed. The clip 522 can allow the user to select a rotational orientation of the rod 520 so that a plurality of rods 520 can have a three dimensional configuration (as shown in FIG. 7B).

To use this embodiment, the user cuts a hole 24 in the layer of ice 22 on top of the body of water 20 and places the weight 512 through a hole 24 in the ice 22 into the water 20 (clearly, the weight must have a diameter that is less than the diameter of the hole 24). The user then feeds the rod 520 and artificial weed bundles 120 vertically through the hole 24. Once under the ice 22, the rods 520 will move to a horizontal position. To retrieve the system 500, the user can pull the line 510 up and hook an end of the rods 520 with a hook attached to the end of a pole (not shown), thereby pulling one end of each rod 520 up through the hole 24. Alternately, a thin fishing line can be attached to the ends of the rods 520, with one end remaining above the ice layer 22. To retrieve the system 500, the user would simply pull up on the fishing line until the rods 520 are in a vertical position and then the user would simply lift the rods 520, the line 510 and the weight 512 out of the hole.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. An artificial weed system for attracting fish while ice fishing, comprising:
(a) a flexible line having a distal end;
(b) at least one elongated rod affixed to the line at a predetermined position;
(c) at least one artificial weed bundle affixed to the rod and including a first end that is affixed to the rod, each of the at least one artificial weed bundles including a plurality of strands extending from the first end, each strand having a specific gravity that is no greater than 1.0 and each strand comprising a synthetic filament; and
(d) a weight affixed to the distal end of the line.

2. The artificial weed system of claim 1, wherein the weight is elongated so as to be configured to fit through an ice fishing hole.

3. The artificial weed system of claim 1, further comprising a clip that is configured to fix the elongated rod to a desired vertical position along the line.

4. The artificial weed system of claim 3, wherein the clip is further configured to affix the rod to a desired rotational orientation with respect to the line.

5. The artificial weed system of claim 1, wherein the circular rod comprises a polyvinyl chloride tube.

6. The artificial weed system of claim 1, wherein the plurality of strands comprises an extruded monofilament material selected from a group consisting of: nylons; polyesters, polypropylenes and copolymers thereof.

7. The artificial weed system of claim 1, wherein each of the plurality of strands has a color corresponding to a natural grass found in a body of water.

8. The artificial weed system of claim 1, wherein the plurality of strands comprises:
(a) a plurality of fine crinkled strands; and
(b) a plurality of straight grass blade shaped strands.

9. A method of attracting fish to a location in a body of water that is covered with a layer of ice, comprising the steps of:
(a) drilling a hole, having a diameter, in the layer of ice so as to facilitate access to unfrozen water in the body of water;
(b) placing a weight that is affixed to a line through the hole; and
(c) placing through the hole a vertically disposed elongated rod that is affixed to the line and to which is affixed at least one artificial weed bundle that includes a plurality of elongated strands extending therefrom, each strand comprising a synthetic filament.

10. The method of claim 9, further comprising the step of applying a clip to the rod and to the line so as to affix the rod to a desired vertical position relative to the line.

11. The method of claim 9, wherein the circular rod comprises a polyvinyl chloride tube.

12. The method of claim 9, wherein the plurality of strands comprises an extruded monofilament material selected from a group consisting of: nylons; polyesters, polypropylenes and copolymers thereof.

13. The method of claim 9, wherein each of the plurality of strands includes a material that has a specific gravity of no greater than 1.0.

14. The method of claim 9, wherein each of the plurality of strands has a color corresponding to a natural grass found in a body of water.

15. The method of claim 9, wherein the plurality of strands comprises:
(a) a plurality of fine crinkled strands; and
(b) a plurality of straight grass blade shaped strands.

16. The method of claim 9, wherein the weight has a diameter that is less than the diameter of the hole.

17. The method of claim 9, wherein the vertically disposed elongated rod and the artificial weed bundle together have a diameter less than the diameter of the hole.
